(19) United States
(12) Patent Application Publication
(10) Pub. No.: US 2026/0204791 A1
(43) Pub. Date: Jul. 16, 2026

(54) Multiband Slot Antenna

(71) Applicant: Vitro Automotive Holdings Corporation, Cheswick, PA (US)

(72) Inventor: David Dai, Cheswick, PA (US)

(21) Appl. No.: 19/449,312

(22) Filed: Jan. 14, 2026

Related U.S. Application Data
(60) Provisional application No. 63/745,662, filed on Jan. 15, 2025.

(51) Int. Cl. H01Q 13/10; H01Q 1/22; H01Q 5/20; H01Q 1/32

(52) U.S. Cl. CPC H01Q 13/10; H01Q 1/2291; H01Q 5/20; H01Q 1/32

(57) ABSTRACT

An antenna assembly may include a conductive layer arranged on a surface of a glazing; a plurality of slots defined on a surface of the conductive layer, which may include a first slot having a first length; and a second slot having a second length greater than the first length; and a transmission line electrically connected to the first slot and the second slot at a feed position. The first slot may be parallel to at least a portion of the second slot. The first slot and the second slot may both comprise TE10, TE20, and TE30 modes. The electrical connection with the transmission line may excite at least one of the TE10, TE20, or TE30 modes of at least one of the first slot or the second slot.

### CROSS REFERENCE TO RELATED APPLICATIONS

This application claims priority to United States Provisional Application No. 63/745,662, filed on January 15, 2025, the disclosure of which is hereby incorporated by reference in its entirety.

### BACKGROUND OF THE INVENTION

### Field of the Invention

The present application relates to a slot antenna and, more particularly, to a dual slot antenna comprising two slot radiators of different lengths having a single feed for applications in, particularly but not exclusively, Wireless Local Area Networks (WLAN) operating in multiple frequency bands.

### Description of Related Art

In automotive glazings such as windshields and back windows, antennas for the reception and/or transmission of radio frequency waves such as AM, FM, TV, DAB, RKE, etc. are often carried on or incorporated in the glazing. Such antennas have been formed by printing conductive lines such as silver or copper onto a glazing transparency or by laminating metal wires or strips between transparency layers of the vehicle glazing. Such antennas offer advantages of aerodynamic performance for the vehicle as well as provide an aesthetically pleasing, streamline appearance for the vehicle.

A modern vehicle typically supports communication over several different wireless interfaces such as Wi-Fi, Bluetooth, mobile network, vehicle-to-vehicle (V2V), GNSS, etc. These wireless communication technologies enable new use cases to improve the user experience as well as new features and functions such as autonomous driving and route navigation. A modern vehicle has multiple networks for sharing information, including wireless channels to support various use cases. For example, a car can broadcast a Wi-Fi signal that enables passengers to connect their devices to access all the internet has to offer, i.e., from web browsing, to streaming movies and music on tablets and laptops. Bluetooth communication allows one to connect a phone to the vehicle's infotainment system to make calls, listen to music, and more without having to hold the phone. Bluetooth Low Energy communication technologies is also used for smart key or smartphone wireless access when approaching a car between the key fob and vehicle. Each wireless interface, whether by cellular, WLAN, Bluetooth or V2V, requires an antenna that supports the respective communication channel. In some cases, multiple antennas may be required for each wireless communication. Designing antennas that can be accommodated by space that is available on the vehicle presents a significant challenge. Integrating antennas in the vehicle glazing offers advantages of improved aesthetics, simplified antenna packaging, reduced weight, discouraging theft and vandalism, and eliminating holes in the vehicle body that are prone to water invasion and other problems. Therefore, there has been a need for antennas that are capable of operating at multiband WLAN frequencies and that can be mounted on a vehicle without protruding from the exterior of the vehicle or into the interior passenger compartment.

US Patent 6,677,909 B2 illustrates a dual band slot antenna including a first and a second slot of different length. A coaxial cable feeds both slots as a common feedline for dual band applications. US Patent 7,129,902 B2 describes a dual slot antenna comprised of two slots of different lengths with a single feed. A microstrip feed line excites both slots of different lengths to facilitate multi-frequencies of operation. US Patent 8,912,966 B2 illustrates a dual band slot antenna with three branches. The first resonant frequency comes from the combination of the first and third branch and the second resonant frequency is provided by the combination of the second and the third branch. US Patent 9,099,789 B1 discloses a dual-band inverted slot antenna with two open ends configured to transmit and receive electromagnetic signals at two frequency bands.

The rapid growth in connected vehicle communications has given rise to a need to integrate more antennas on the vehicle. There is, therefore, a need for DSRC, Wi-Fi, WLAN and Bluetooth antennas that can be mounted to a surface of the vehicle, but that do not extend from the exterior of the vehicle or protrude into the interior passenger compartment. In addition, there is a practical need that such antennas can be accommodated by existing vehicle parts as standard equipment with minimum cost. Still further, it is also important that such antennas maintain the aesthetic or appearance of the vehicle and require only limited modification to existing glazing structure and manufacturing processes. Furthermore, there is also need for a single antenna having multi-band characteristics which can receive and transmit over the entire WLAN frequency bands.

### SUMMARY OF THE INVENTION

In some embodiments or aspects, the present disclosure may be characterized by one or more of the following numbered clauses:

Clause 1. An antenna assembly comprising: a conductive layer arranged on a surface of a glazing; a plurality of slots defined on a surface of the conductive layer, the plurality of slots comprising: a first slot having a first length; and a second slot having a second length greater than the first length; and a transmission line electrically connected to the first slot and the second slot at a feed position, wherein the first slot is parallel to at least a portion of the second slot, wherein the first slot and the second slot both comprise TE10, TE20, and TE30, modes, and wherein electrical connection with the transmission line excites at least one of the TE10, TE20, or TE30 modes of at least one of the first slot or the second slot.

Clause 2. The antenna assembly of clause 1, wherein the feed position is at a midpoint of the first slot and the second slot.

Clause 3. The antenna assembly of clause 1 or 2, wherein the first slot and the second slot are configured such that the electrical connection with the transmission line excites at least the TE10 modes of the first slot and the second slot and the TE30 mode of the second slot, and wherein the TE30 mode of the second slot comprises a first TE30 resonant frequency.

Clause 4. The antenna assembly of clause 3 further comprising a first slit and a second slit extending from the second slot at points of the second slot that are parallel to the first slot.

Clause 5. The antenna assembly of clause 4, wherein the first slit and the second slit extend from the second slot at minimum points of an electrical field of the TE30 mode of the second slot generated along the second slot.

Clause 6. The antenna assembly of clause 5, wherein the first slit and the second slit are configured to increase the second length, such that the TE30 mode of the second slot comprises a second TE30 resonant frequency less than the first TE30 resonant frequency.

Clause 7. The antenna assembly of clause 6, wherein the first slit and the second slit are configured to increase the second length, such that the TE30 mode of the second slot comprises a second TE30 resonant frequency less than the first TE30 resonant wherein the TE10 mode of the first slot comprises a first TE10 resonant frequency, and wherein the TE10 mode of the second slot comprises a second TE10 resonant frequency less than the first TE10 resonant frequency.

Clause 8. The antenna assembly of clause 7, wherein the first TE10 resonant frequency is WLAN 5.2 GHz.

wherein the second TE10 resonant frequency is WLAN 2.4 GHz, and wherein the second TE30 resonant frequency is WLAN 3.6 GHz.

Clause 9. The antenna assembly of clause 8, wherein the second slot is U-shaped, and wherein the first slot is arranged within the second slot.

Clause 10. The antenna assembly of any of clauses 1-9, wherein the transmission line comprises a microstrip line capacitively connected to the first slot and the second slot.

Clause 11. The antenna assembly of clause 10 further comprising a substrate, wherein the conductive layer is arranged on a first surface of the substrate and the microstrip line is arranged on a second surface of the substrate opposite the first surface.

Clause 12. The antenna assembly of any of clauses 1-11, wherein the feed position is located at a one-quarter point of the first slot and a one-sixth position of the second slot.

Clause 13. The antenna assembly of clause 12, wherein the transmission line comprises a coaxial cable comprising a center conductor and an outer shield, wherein the outer shield is connected to a side of the first slot and the center conductor, and wherein the center conductor extends across the first slot and the second slot at the feed position and is connected to a side of the second slot.

Clause 14. The antenna assembly of clause 13, wherein the first slot and the second slot are configured such that the electrical connection with the transmission line excites at least the TE10 modes of the first slot and the second slot, the TE20 modes of the first slot and the second slot, and the TE30 mode of the second slot, wherein the TE20 mode of the first slot has a first TE20 resonant frequency, and wherein the TE20 mode of the second slot has a second TE20 resonant frequency.

Clause 15. The antenna assembly of clause 14, further comprising at least one third slit extending from at least one of the first slot and the second slot.

Clause 16. The antenna assembly of clause 15, wherein the at least one third slit extends from the first slot at a minimum point of an electrical field of the TE20 mode of the first slot generated along the first slot.

Clause 17. The antenna assembly of clause 16, wherein the at least one third slit is configured to increase the first length, such that the TE20 mode of the first slot comprises a second TE20 resonant frequency less than the first TE20 resonant frequency.

Clause 18. An antenna window assembly comprising: surface; an inner transparent ply comprising a third surface and a fourth surface opposite the third surface; an interlayer disposed between the second surface and the third surface; a conductive layer arranged on the fourth surface;

a first slot defined on a surface of the conductive layer; a second slot defined on a surface of the conductive layer; and a transmission line electrically connected to the first slot and the second slot at a feed position, wherein the first slot has a first length, and the second slot has a second length greater than the first length, wherein the first slot is parallel to at least a portion of the second slot, wherein the first slot and the second slot both comprise TE10, TE20, and TE30 modes, and wherein electrical connection with the transmission line excites at least one of the TE10, TE20, or TE30 modes of at least one of the first slot or the second slot.

Clause 19. The antenna assembly of clause 18 further comprising a first slit and a second slit extending from the second slot at minimum points of an electrical field of the TE30 mode of the second slot generated along the second slot.

Clause 20. The antenna assembly of clause 19, wherein the first slit and the second slit are configured to increase the second length and reduce a resonant frequency of the TE30 mode of the second slot.

### BRIEF DESCRIPTION OF THE DRAWINGS

FIG. 1 is a top view of a vehicle having an antenna according to one non-limiting embodiment or aspect of the present disclosure.

FIG. 2 is a first partial cross-sectional view of the vehicle of FIG. 1 along line 2-2.

FIG. 3 is a second partial cross-sectional view of the vehicle of FIG. 1 along line 2-2.

FIG. 4 is a top view of a dual slot antenna according to one non-limiting embodiment or aspect of the present disclosure.

FIG. 5 is an illustrative example of an electrical field distribution in a slot of a slot antenna according to one non-limiting embodiment or aspect of the present disclosure.

FIG. 6 is a perspective view of a dual slot antenna having a microstrip antenna feed line according to one non-limiting embodiment or aspect of the present disclosure.

FIG. 7 is a first top view of a dual slot antenna having a coaxial cable antenna feed line according to one non-limiting embodiment or aspect of the present disclosure; and

FIG. 8 is a second top view of a dual slot antenna having a coaxial cable antenna feed line according to one non-limiting embodiment or aspect of the present disclosure.

### DESCRIPTION OF THE INVENTION

For purposes of the description hereinafter, the terms “upper”, “up”, “lower”, “down”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

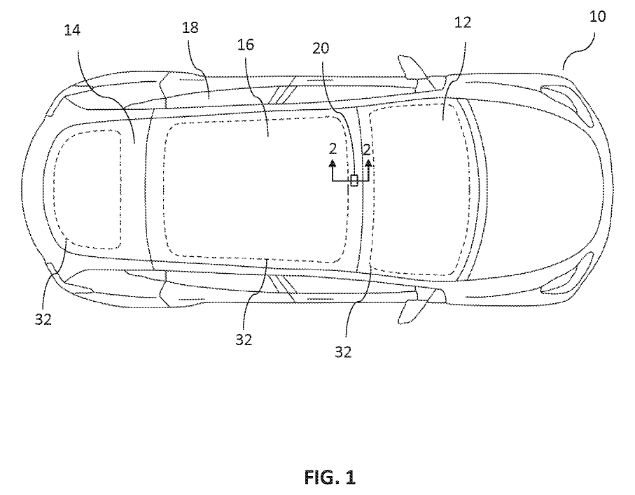

The present disclosure relates to antennas 20 used in glass, such as glass used in motor vehicles 10, an example of which is shown in FIG. 1. The antennas 20 are used to resonate at different bands to pick up and receive signals that can be used for AM, FM, digital audio broad cast (DAB), digital television (TV), broad band and other applications. While some or all of these signals and applications may be used in connection with a motor vehicle 10, the antennas 20 disclosed are not intended to be limited to use in motor vehicles 10 like the one shown. One will appreciate that the antennas 20 can be used with glass in other applications. For example, the antennas can be used with other vehicles or modes of transportation, such as trucks, busses, boats and airplanes. In other examples, the antennas 20 can be used in non-vehicular glass applications. such as on building windows or within smart glass or privacy glass used inside of buildings. The antenna 20 may also be used in applications, automotive or otherwise, that possess dielectric structures, not only glass that includes transparent or translucent surfaces.

With reference to FIG. 1, a motor vehicle 10 (hereinafter the “vehicle”) having an antenna 20 according to one non-limiting aspect or embodiment of the present disclosure is shown. The vehicle 10 includes a windshield 12, back window 14, roof window 16, and passenger windows 18. The windshield 12, back window 14, roof window 16, and passenger windows 18 are typically made of glass. The windshield 12, back window 14, and roof window 16 may include respective concealment bands 32 extending about a perimeter thereof. The concealment bads 32 conceal different elements of the antenna 20 and other electronic equipment located around the edges of the respective windows 12, 14, 16. The area where the antenna and other electronic equipment may be covered by a concealment band 32 is known as the silhouette of the concealment band 32. Generally, the concealment bands 32 may be applied by screen printing an opaque ink onto the glazing of the glass and firing the perimeter of the glass. The concealment bands 32 may be a paint band that is screen printed onto the glazing of the glass. The windshield 12, back window 14, and roof window 16 are held within a body of the vehicle 10. The antenna 20 may be arranged in or around any one of the windows 12, 14, 16. However, as shown, the antenna 20 is arranged proximate to the roof window 16. Specifically, the antenna 20 is arranged adjacent to a front end of the roof window 16 near the windshield 12. However, the antenna 20 may be arranged around the roof window 16 at any point along the vehicle 10. The antenna 20 may be arranged within an area around the concealment band 32 of the roof window 16, such as the silhouette of the concealment band 32.

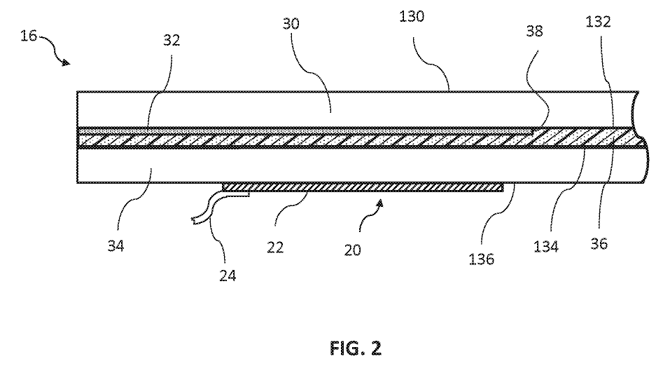

With reference to FIG. 2, a partial cross-sectional view of one non limiting-embodiment of the antenna 20 in the roof window 16 is shown. The roof window 16 is a laminated glazing that includes an inner transparent ply 34 and outer transparent ply 30. The roof window 16 may be referred to as a glazing 16 below. The transparent plies 30, 34 may be composed of glass. The inner ply 34 and outer ply 30 are bonded together by an interlayer layer 36. The interlayer 36 may be made of a polyvinyl butyral or similar material, such as polyethylene terephthalate (PET). The outer ply 30 has an outer surface 130 that defines the outside or outwardly facing surface of the roof window 16. The outer surface 130 may be conventionally referred to as a first surface. The outer ply also defines an inner surface 132 that is oppositely disposed on outer ply 30 from outer surface 130. The inner surface 132 may be conventionally referred to as a second surface. The inner ply 34 has an outer surface 134 that faces away from the vehicle passenger compartment and faces internally in the glazing 16 so that it is opposite the inner surface 132 of the outer transparent ply 30. The outer surface 134 may be conventionally referred to as a third surface. The inner transparent ply 34 also defines an inner surface 136 that defines the inside or inwardly facing surface of the glazing 16 such that it faces internally to the passenger compartment of the vehicle. The inner surface 136 may be conventionally referred to as a fourth surface. The interlayer 36 is located between the second and third surfaces 132, 134.

As shown in FIGS. 1 and 2, the glazing 16 includes concealment band 32 that is applied to the inner surface 132 of the outer ply 30. The concealment band 32 has a closed inner edge 38 that defines the boundary of the daylight opening (DLO) of the glazing 16. The concealment band 32 is sufficiently wide to cover elements of the antenna 20 as well as other electronic features that are included near the outer perimeter of the glazing 16 as hereinafter shown and described.

One or more conductive layers 22 are disposed or formed on the inner surface 136 of the inner ply 34. The interlayer 36, inner ply 34 and outer ply 30 may act as a dielectric substrate for the conductive layer 22. A transmission line 24 is connected to the conductive layer 22 to provide an electrical connection to the conductive layer 22 and/or the antenna 20. The antenna 20 is arranged on and may include the conductive layer 22. The antenna 20 may also be printed directedly on the outer surface 136 and conductive layer 22 may be omitted.

The conductive layer 22 may be implemented in many ways that are given by way of example here. However, one will appreciate that other implementations not described may be used. The conductive layer 22 may be a conductive paint, a metallic film deposited by sputtering or vapor deposition, a silver past screen meshed to a nonconductive panel. Furthermore, the conductive layer 22 may be formed on the surfaces of a single layer nonconductive pane such as a tempered glass window, like inner ply 34, or the surfaces of any one of the multilayer glass or plastic layers of a laminated transparency or bonded on the surfaces of a non-conductive body panel, such as fiberglass, interior or exterior panel.

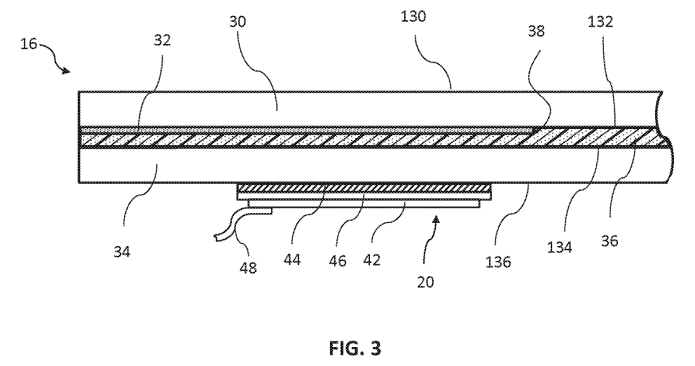

With reference to FIG. 3, a partial cross-sectional view of another non-limiting embodiment of the antenna 20 in the roof window 16 is shown. Roof glazing 16 includes an inner transparent ply 34, an outer transparent ply 30 and a PVB interlayer 36 therebetween. One or more conductive layers 42 are arranged or formed on a thin, flexible film substrate 46, such as polyester PET), Kapton, mylar, or any other flexible dielectric substrate. The conductive layer 42 and film substrate 46 are secured to the surface 136 of the inner ply 34 by an adhesive layer 44. The adhesive layer 44 can be any suitable adhesive or transfer tape that effectively allows the substrate 46 to be secured to the inner ply 34. A transmission line 48 is connected to the conductive layer 42.

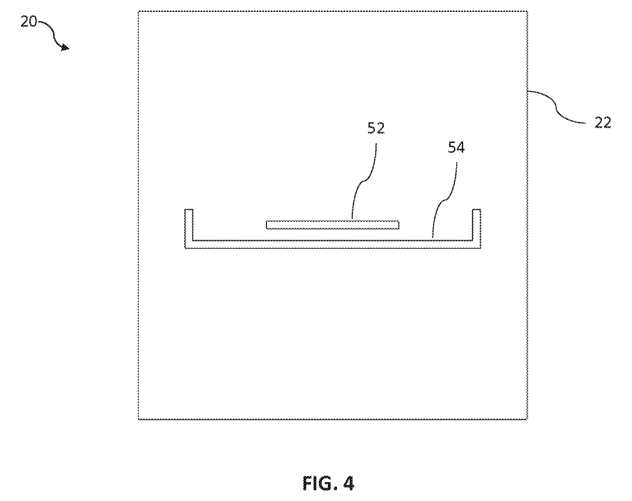

With reference to FIG. 4, one arrangement of the antenna 20, which can be used in the examples of different antennas 20a, 20b, 20c described below, is shown. The conductive layer 22 (or conductive layer 42) acts as an electrical ground plane. The conductive layer 22 defines a first slot 52 and a second slot 54. The first slot 52 extends the conductive layer 22 and is arranged symmetrically with respect to a longitudinal axis intersecting the center of conductive layer 22. The second slot 54 is spaced apart from the first slot 54. The second slot 54 has a greater length than the first slot 52 and extends beyond the ends of the first slot 52. As shown, the second slot 54 has a center portion and opposing ends. The center portion extends parallel to the first slot 52, and the opposing ends extend in a direction orthogonal to the first slot 52. In this arrangement, the second slot 54 takes a U-shape around three sides of the first slot 52. However, the first slot 52 and second slot 54 may have various profile shapes such as, for example, a straight, L-shaped or U-shaped slot. The slots 52, 54 may have different resonant frequencies depending on their shapes and dimensions, and therefore, these may be adjusted depending on the application of the antenna 20.

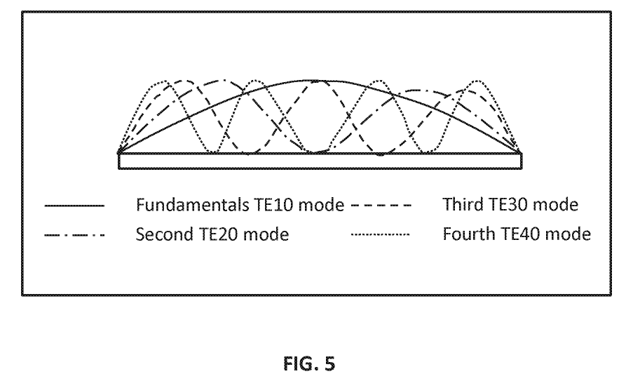

If a slot is excited by electromagnetic waves, then the electrical field distribution in the slot can be constructed by a set of orthogonal modes, such as TE10, TE20, TE30, TE40. For a long thin slot, which may be the first and second slots 52, 54, the amplitudes of the electrical fields of the modes have an integer-number, sine type periodicity along the slot length as shown in FIG. 5. In FIG. 5, an exemplary slot is shown below the periods of TE10, TE20, TE30, and TE40 modes. With this arrangement, it is possible to excite one or more of these orthogonal modes in preference to other modes by feeding the slot at position(s) along its length corresponding to maximum(s) of the periods and/or amplitude(s) of the electric field distributions for the different modes. Using the example shown in FIG. 5, at the center of the slot the odd modes (e.g., TE10 and TE30) have a maximum value, and the even modes (e.g., TE20 and TE40) have a minimum value at the center of the slot. Therefore, when the slot is fed and/or excited at or proximate to its center, it will couple to the odd modes but not the even modes. The coupling to the odd modes may be referred to as strong, whereas coupling, if any, to the even modes may be referred to as weak. Coupling to the even modes may be at or near zero. In another example from FIG. 5, if the slot is fed and/or excited inward from one of its ends, at point equal to approximately one-sixth of the total length of the slot, then this will couple all of the modes because all the modes are at or near a maximum at this feed point.

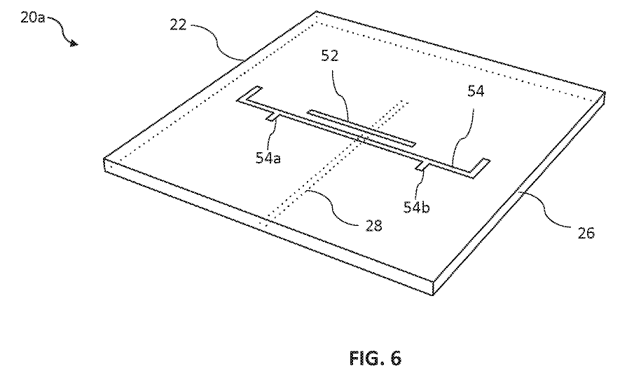

With reference to FIG. 6, a first example of an antenna 20a is shown. The antenna 20a has a conductive layer 22 defining a first slot 52 of a first length and a second slot 54 of a second length, which is greater than the first length. The first slot 52 and the second slot 54 are aligned in the middle of the conductive layer 22 and are arranged similar to the example shown in FIG. 4. However, different from FIG. 4, the conductive layer 22 is arranged on a substrate 26. The substrate 26 defines a microstrip line 28 on a side that is opposite to the conductive layer 22. The microstrip line 28 may be capacitively coupled to the conductive layer 22. In other examples, the substrate 26 may include electrical connections extending from the microstrip line 28 to the conductive layer 22. The characteristic impedance and width of the microstrip line 28 affect its electromagnetic connections to the first and second slot 52, 54. For the strongest connection, the microstrip line 28 can be oriented along the substrate 26, so that it extends orthogonally to the parallel portions of the first and second slots 52, 54. The microstrip line 28 terminates with an open circuit quarter-wavelength line that may be matched with a desired antenna 20a. The second slot 54 includes slits 54a, 54b extending from points along its center portion.

The microstrip line 28 extends along the substrate 26 to feed the first and second slots 52, 54 proximate to their midpoints to excite the respective odd modes (e.g.,, TE10 and TE30) of the slots 52, 54 The second slot 54 may be arranged so that the resonant frequency of the TE10 mode is tuned to WLAN 2.4 GHz, and the resonant frequency of the TE30 mode is tuned to approximately 5.6 GHz. To use the TE30 mode of the second slot 54, the two slits 54a, 54b shown in FIG. 6 can be arranged along the slot 54 at two minimum points of the electrical field distribution for the TE30 mode. With this arrangement, the resonate frequency of 5.6 GHz may be shifted down to WLAN 3.6 GHz. The length of the slits 54a, 54b may be adjusted such that the resonant frequency of TE30 mode meets a targeted or desired frequency. This occurs because the electrical field of the TE30 mode is out of phase at the locations of the slits 54a, 54b, which results in the electrical field of the TE30 mode being added constructively. This essentially extends the length of the second slot 54 with respect to the TE30 mode and lowers its resonant frequency. The slits 54a, 54b have minimal impact on the resonant frequency of the TE10 mode because the electrical field of the TE10 mode are in phase at the locations of the slits 54a, 54b. in other words, the electrical field on two sides of the slits 54a, 54b cancel each other out, which satisfies an electrical field boundary condition. with respect to the first slot 52, the TE10 mode may be tuned to wlan 5.2 ghz, and the TE30 mode may or may not be used. as shown, the TE30 mode of first slot 52 is not used because the frequency is too high for typical applications of the antenna 20a. with this arrangement of the first and second slots 52, 54, the antenna 20a can be used in three different frequency bands, i.e., wlan 2.4 ghz, wlan 3.6 ghz, and wlan 5.2 ghz bands.

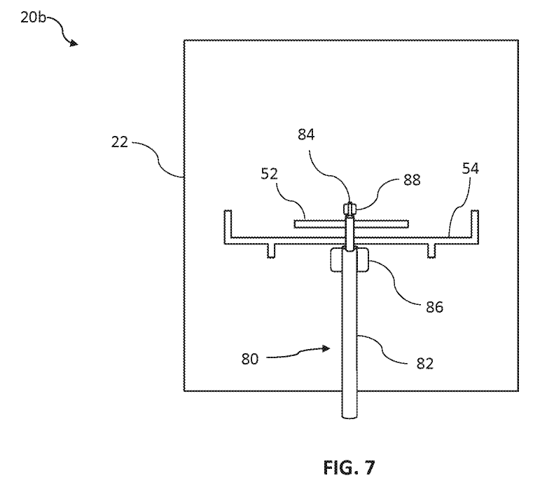

With reference to FIG. 7, a second example of an antenna 20b is shown. The antenna 20b is fed directly through the first and second slots 52, 54 using a coaxial cable 80. The coaxial cable 80 has a center conductor 84 and an outer shield 82. The center conductor 84 extends over the first and second slots 52, 54 and is galvanically connected to the farthest side of the first slot 52 at a solder pad 88 on the conductive layer 22. The outer shield 82 is galvanically connected to the nearest side of the second slot 54 at a solder pad 86 on the conductive layer 22. This arrangement allows the antenna to be more readily incorporated with physical component parts already in use in current glazings 16 using existing manufacturing processes. This antenna 20b may also be more easily and conveniently connected by conductive connections to external electronic circuitry.

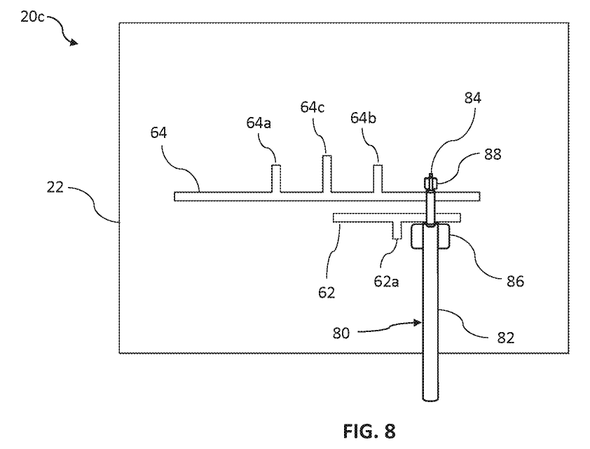

With reference to FIG. 8, a third example of an antenna 20c is shown. The antenna 20c is formed on a conductive layer 22 and includes first slot 62 of a first length and a second slot 64 of a second length that is greater than the first length. The first slot 62 and the second slot 64 have portions that are arranged parallel to each other. The first slot 62 and the second slot 64 are aligned at a feed point. With respect to the first slot 62, the feed point is defined at a one-quarter point along the length of the first slot 62. In other words, the feed point is defined one quarter of the way inward from an end of the first slot 62. For example, if the first slot 62 has a length of 100mm, then the feed point is defined along the first slot 62 at a point that is 25mm from an end of the first slot 62. The feed point of the second slot 64 is defined at a one-sixth point along the length of the second slot 64. In other words, the feed point is defined one sixth of the way inward from an end of the second slot 64. For example, if the second slot 64 has a length of 100mm, then the feed point is defined along the second slot 64 at a point that is approximately 16.67mm from an end of the second slot 64.

A coaxial cable 80 feeds the first and second slots 62, 64 at their respective feed points to excite the odd and even modes of the slots 62, 64. With respect to the second slot 64, the resonant frequency of the TE10 mode is tuned to WLAN 2.4 GHz, the resonant frequency of the TE20 mode is tuned to 4.4 GHz, and the resonant frequency of the TE30 mode is tuned to 5.8 GHz. The TE20 mode may be tuned to WLAN 3.6 GHz by way of a slit 64c. For this, the slit 64c is arranged on the second slot 64 at a minimum point of the TE20 mode, as shown in FIG. 8. The length of the slit 64c may be modified so that the resonate frequency of TE20 mode meets a targeted or desired frequency that is different from WLAN 3.6 GHz. Similar to the example shown in FIG. 7, the TE30 mode of slot 64 may be shifted to WLAN 4.9 GHz from 5.9 GHz by introducing the slits 64a, 64b at two minimum points of the TE30 mode on the second slot 64. With respect to the first slot 62, the TE10 mode has a resonant frequency of WLAN 5.2 GHz, the resonate frequency of the TE20 mode may be shifted to WLAN 5.8 GHz by introducing slit 62a at minimum point of the TE20 mode of the slot 62. With this practice, the fundamental and higher order modes of the slot antenna can be used in five different frequency bands, i.e., WLAN 2.4 GHz, WLAN 3.6 GHz, WLAN 5.9 GHz, WLAN 5.2 GHz, and WLAN 5.8 GHz bands.

While several non-limiting embodiments of the presently disclosed invention have been shown and described herein, those skilled in the art will recognize various modifications that may be adopted without departing from the spirit of the disclosed invention as set forth in the following claims.

While the invention has been described and illustrated by reference to certain preferred embodiments and implementations, it should be understood that various modifications may be adopted without departing from the spirit of the invention or the scope of the following claims.

1. An antenna assembly comprising:
a conductive layer arranged on a surface of a glazing;
a plurality of slots defined on a surface of the conductive layer, the plurality of slots comprising:
a first slot having a first length; and
a second slot having a second length greater than the first length; and
a transmission line electrically connected to the first slot and the second slot at a feed position,
wherein the first slot is parallel to at least a portion of the second slot,
wherein the first slot and the second slot both comprise TE10, TE20, and TE30, modes, and
wherein electrical connection with the transmission line excites at least one of the TE10, TE20, or TE30 modes of at least one of the first slot or the second slot.

2. The antenna assembly of claim 1, wherein the feed position is at a midpoint of the first slot and the second slot.

3. The antenna assembly of claim 1, wherein the first slot and the second slot are configured such that the electrical connection with the transmission line excites at least the TE10 modes of the first slot and the second slot and the TE30 mode of the second slot, and
wherein the TE30 mode of the second slot comprises a first TE30 resonant frequency.

4. The antenna assembly of claim 3 further comprising a first slit and a second slit extending from the second slot at points of the second slot that are parallel to the first slot.

5. The antenna assembly of claim 4, wherein the first slit and the second slit extend from the second slot at minimum points of an electrical field of the TE30 mode of the second slot generated along the second slot.

6. The antenna assembly of claim 5, wherein the first slit and the second slit are configured to increase the second length, such that the TE30 mode of the second slot comprises a second TE30 resonant frequency less than the first TE30 resonant frequency.

7. The antenna assembly of claim 6, wherein the TE10 mode of the first slot comprises a first TE10 resonant frequency, and
wherein the TE10 mode of the second slot comprises a second TE10 resonant frequency less than the first TE10 resonant frequency.

8. The antenna assembly of claim 7, wherein the first TE10 resonant frequency is WLAN 5.2 GHz,
wherein the second TE10 resonant frequency is WLAN 2.4 GHz, and
wherein the second TE30 resonant frequency is WLAN 3.6 GHz.

9. The antenna assembly of claim 8, wherein the second slot is U-shaped, and
wherein the first slot is arranged within the second slot.

10. The antenna assembly of claim 1, wherein the transmission line comprises a microstrip line capacitively connected to the first slot and the second slot.

11. The antenna assembly of claim 10 further comprising a substrate,
wherein the conductive layer is arranged on a first surface of the substrate and the microstrip line is arranged on a second surface of the substrate opposite the first surface.

12. The antenna assembly of claim 1, wherein the feed position is located at a one-quarter point of the first slot and a one-sixth position of the second slot.

13. The antenna assembly of claim 12, wherein the transmission line comprises a coaxial cable comprising a center conductor and an outer shield,
wherein the outer shield is connected to a side of the first slot and the center conductor, and
wherein the center conductor extends across the first slot and the second slot at the feed position and is connected to a side of the second slot.

14. The antenna assembly of claim 13, wherein the first slot and the second slot are configured such that the electrical connection with the transmission line excites at least the TE10 modes of the first slot and the second slot, the TE20 modes of the first slot and the second slot, and the TE30 mode of the second slot,
wherein the TE20 mode of the first slot has a first TE20 resonant frequency, and
wherein the TE20 mode of the second slot has a second TE20 resonant frequency.

15. The antenna assembly of claim 14 further comprising at least one third slit extending from at least one of the first slot and the second slot.

16. The antenna assembly of claim 15, wherein the at least one third slit extends from the first slot at a minimum point of an electrical field of the TE20 mode of the first slot generated along the first slot.

17. The antenna assembly of claim 16, wherein the at least one third slit is configured to increase the first length, such that the TE20 mode of the first slot comprises a second TE20 resonant frequency less than the first TE20 resonant frequency.

18. An antenna window assembly comprising:
a first outer transparent ply comprising a first surface and a second surface opposite the first surface;
an inner transparent ply comprising a third surface and a fourth surface opposite the third surface;
an interlayer disposed between the second surface and the third surface;
a conductive layer arranged on the fourth surface;
a first slot defined on a surface of the conductive layer;
a second slot defined on a surface of the conductive layer; and
a transmission line electrically connected to the first slot and the second slot at a feed position,
wherein the first slot has a first length, and the second slot has a second length greater than the first length,
wherein the first slot is parallel to at least a portion of the second slot,
wherein the first slot and the second slot both comprise TE10, TE20, and TE30 modes, and
wherein electrical connection with the transmission line excites at least one of the TE10, TE20, or TE30 modes of at least one of the first slot or the second slot.

19. The antenna window assembly of claim 18 further comprising a first slit and a second slit extending from the second slot at minimum points of an electrical field of the TE30 mode of the second slot generated along the second slot.

20. The antenna window assembly of claim 19, wherein the first slit and the second slit are configured to increase the second length and reduce a resonant frequency of the TE30 mode of the second slot.
